(19) United States
(12) Patent Application Publication
(10) Pub. No.: US 2013/0149664 A1
(43) Pub. Date: Jun. 13, 2013

(54) SYRINGE APPARATUS

(71) Applicant: Lorraine SAN MIGUEL, Universal City, TX (US)

(72) Inventor: Lorraine SAN MIGUEL, Universal City, TX (US)

(21) Appl. No.: 13/711,456

(22) Filed: Dec. 11, 2012

Related U.S. Application Data
(60) Provisional application No. 61/569,392, filed on Dec. 12, 2011.

(51) Int. Cl. A61C 5/04

(52) U.S. Cl. CPC A61C 5/04
USPC 433/90

(57) ABSTRACT

The present invention is designed to prevent or reduce anxiety in child or adolescent patients undergoing dental or medical procedures through a design to conceal or hide elements of a traditional syringe. The use of an opaque sleeve or exterior surface shaped in a manner other than a tube is used to conceal the interior of the syringe barrel, mask the plunger, and partially obstruct the view of the cannula assembly.

### CROSS-REFERENCES TO RELATED APPLICATIONS

This original nonprovisional application claims the benefit of U.S. provisional application No. 61/569,392, filed Dec. 12, 2012 and entitled “Syringe with Concealing Functionality,” which is incorporated by reference herein.

### STATEMENT REGARDING FEDERALLY SPONSORED RESEARCH OR DEVELOPMENT

Not applicable.

### BACKGROUND OF THE INVENTION

1. Field of the Invention

The present invention relates to the field of syringes in dental and medical applications. Specifically, this invention relates to concealing the functionality of a syringe to reduce anxiety and apprehension in patients.

2. Description of the Related Art

The standard syringe has multiple uses in the medical/dental setting including delivering injections, delivering acid etch to tooth surfaces, and delivering pit and fissure sealant/flowable composite to tooth surfaces. Many dental procedures, such as delivery of acid etch and sealant, a syringe is utilized to supply small amounts of liquid to localized spots without subcutaneous injection. Unlike a standard injection, this process is lengthy requiring the syringe to be in continuous use as the dentist or hygienist conducts the procedure. This results in the syringe being around the patient's face and vision for a substantial period of time.

The standard syringe used in these lengthy procedures generally consists of a syringe barrel, plunger, and needle. The syringe barrel is transparent allowing visibility of the liquid in the syringe visible from all sides and angles, including to the patient. The plunger is usually a piece of clear or translucent material and the rubber stop is generally black. The plunger is usually visible from all angles, including the portion of the plunger located within the syringe barrel. The standard cannula assembly usually includes a needle connected to translucent plastic that shows the internal fluid pathway and connection mechanism to the syringe. For some patients, particularly children and adolescents, the use of a syringe with these characteristics resembles the syringe used to give a patient intraoral injection. Due to the extended use period of such a syringe in some dental applications as described above, many of these patients continually fear they will receive a “shot” which causes apprehension and anxiety resulting in poor patient compliance and longer than necessary procedures. Thus, a new syringe that conceals or hides aspects of a standard syringe would provide substantial benefit to treatment of patients.

### BRIEF SUMMARY OF THE INVENTION

The present invention comprises a syringe apparatus designed to conceal and hide many aspects of a standard syringe including the syringe barrel, plunger, and cannula assembly. The elements of the present invention combine to disguise the appearance of the syringe to help reduce anxiety in patients.

In the preferred embodiment, a syringe barrel, containing standard predetermined markings to indicate volume of fluid in syringe, is covered by a permanently affixed opaque sleeve. The opaque sleeve is molded into a shape, that differs from the standard syringe barrel and may shaped into the form of an animal, object such as a rocket ship, or a patterned design. The opaque sleeve conceals the interior of the syringe barrel and extends beyond the edge of the syringe barrel concealing a portion of where the cannula assembly attaches to the syringe barrel. An inspection window is positioned on one side of the opaque sleeve allowing the predetermined volume marking to be visible to the operator of the syringe. The plunger is shaped comparably to the exterior of the opaque sleeve wherein if the opaque sleeve is an animal, the plunger is shaped to correspond to the animal's tail.

In an alternative embodiment, the opaque sleeve and syringe barrel are manufactured as one element with an exterior surface and interior surface. The interior surface is shaped to form a tube structure to serve as the tubular cavity present in traditional syringes. The exterior surface is opaque and molded into a shape that differs from a standard tube such as animal or object.

### BRIEF DESCRIPTION OF THE FIGURES

FIG. 1 is a profiled view of the preferred embodiment of the present invention.

FIG. 2 is a view of the opposite side of the preferred embodiment as seen in FIG. 1.

FIG. 3 is a profiled view of a second version of the preferred embodiment of the present invention.

FIG. 4 is a view of the opposite side of the second version of the preferred embodiment as seen in FIG. 3.

### DETAILED DESCRIPTION OF VARIOUS EMBODIMENTS

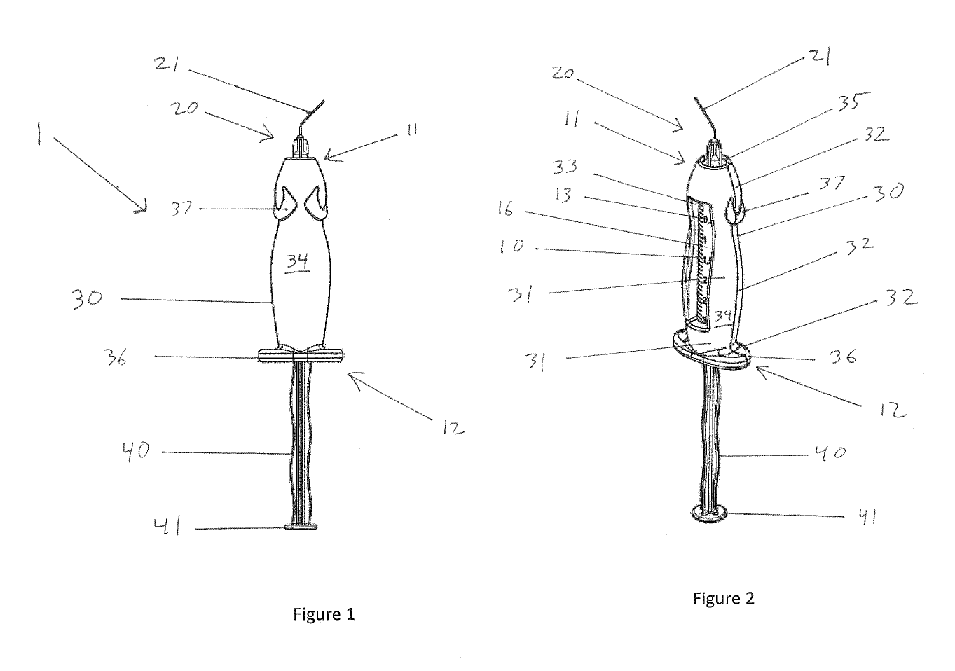

Referring to FIGS. 1 and 2, the preferred embodiment 1 comprises syringe barrel 10, cannula assembly 20, opaque sleeve 30, and a plunger 40. Syringe barrel 10 is cylindrical in shape and defines a circumferentially uniform tubular cavity 16 which is capable of storing fluid or gel based substances. Syringe barrel 10 consists of a first end 11 and second end 12. First end 11 contains a small aperture that is in fluid communication with tubular cavity 16. Internal threads are located on the first end 11 and are capable as serving as an attachment point for a cannula assembly. The aperture is large enough to allow fluid ingress and egress from tubular cavity 16 depending on operation of the plunger. Second end 12 contains an opening with the same circumference as the tubular cavity 16 and is capable of receiving a plunger. Located on the exterior of the syringe barrel 10 is a series of predetermined volume indicators 13. These predetermined volume indicators 13 are arranged along the length of the syringe barrel 10 and extend from the first end 11 to the second end 12, generally moving from a lower volume near the first end 11 and a higher volume near the second end 12. Syringe barrel 10, as described, is a traditional syringe barrel well known in the art.

Cannula assembly 20 contains an angled needle 21 on one end and a raised ridge or a singular external thread on the other end. Depending on the application, a cannula assembly may contain a straight needle as well. The raised ridge or external thread is capable of screwing into the internal threads located on the first end 11 of syringe barrel 10. Once threadably attached, a fluid communication path is established from the tubular cavity 16 to the angled needle 21 through the aperture and cannula assembly 20. Cannula assembly 20 is removable and disposable.

Plunger 40 contains a rubber tip at one end and a push bar 41 at the opposing end. The rubber tip portion is approximately the same circumference of the opening in the second end 12 of the syringe barrel 10 and is of sufficient size to create an airtight seal when inserted.

Opaque sleeve 30 is permanently positioned over syringe barrel 10. Lip 35 extends over a portion of the cannula assembly 20 and conceals the internal threads of syringe barrel and raised ridge/external thread of cannula assembly 20. Lip 35 has substantially the same circumference of syringe barrel 10 to allow for easy removal and attachment of cannula assembly 20. On the opposite side of lip 35 are handles 36 that allow the user to grip apparatus as they push the plunger 40 into the tubular cavity 16.

Opaque sleeve 30 is comprised of a first half 31 and a second half 32. Each half is made of an opaque material or painted with an opaque color and is longitudinally positioned around syringe barrel 10. Each half covers approximately half of the syringe barrel. Once the first half 31 and second half 32 are permanently attached together forming the opaque sleeve 30, the syringe barrel 10 is held in place and inseparable from the opaque sleeve 30. In the preferred embodiment, the two halves are sonically welded together but other attachment means may be utilized.

Disposed through first half 31 is inspection window 33. Inspection window 33 is longitudinally positioned along syringe barrel 10 and matches up with the position of the predetermined volume indicators 13. In the preferred embodiment, inspection window 33 is a portion of the first half 31 that is removed, exposing syringe barrel 10 at the location of the predetermined volume indicators 13. Alternatively, inspection window 33 may be made of a translucent material allowing the predetermined volume indicators 13 to be visible through the first half 31.

In the preferred embodiment, the exterior surface 34 of the opaque sleeve 30 is shaped as an animal such as a mouse, object such as a rocket ship or football, or a patterned design. Exterior surface 34 is shaped in a manner that differs from the syringe barrel in that it is not designed as a substantially uniform tubular shape. Additionally, plunger 40 is shaped to provide a corresponding impression as the exterior surface 34. Plunger 40 may be shaped, but in no event will its shape exceed the circumference of the syringe barrel 10. Plunger 40 maintains sufficient structural integrity to allow the plunger to still be manipulated by the user in a manner similar to the prior art.

As seen in FIGS. 1 and 2, the exterior surface is shaped as mouse with ears 37 molded into the opaque sleeve 30. Exterior surface 34 may be manipulated and changed to correspond with the particular design utilized. For example, a mouse shaped apparatus may have the exterior surface 34 painted gray, eyes glued or painted to the exterior surface, a nose painted onto the exterior surface 34, and plunger 40 shaped to mimic a curly mouse tail. In this example, exterior surface 34 displays a series of contours to mimic the shape of a mouse.

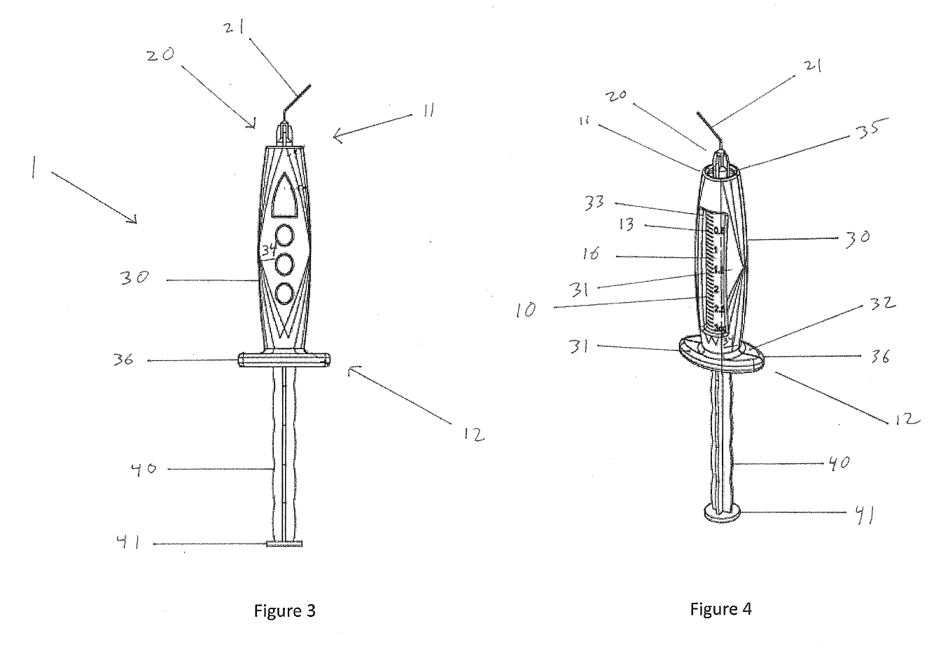

As seen in FIGS. 3 and 4, exterior surface 34 is manipulated to show a rocket ship complete with various button simulations and paint. Plunger 40 is shaped to mimic the exhaust and flame coming from a rocket ship during takeoff.

Other manipulations of exterior surface 34 are envisioned including animals such as a mouse, monkey, tiger, shark, lizard, dog, cat, pig, or duck; objects such as rocket ships, crayon, footballs and other sports equipment; and designs such as pink striped zebras. For animal shapes, plunger 40 is shaped in a manner to correspond to the tail of an animal such as a mouse, monkey, tiger, lizard, dog, cat, pig, or duck, etc.

In an alternative embodiment, first end 11 may contain a conical protrusion instead of internal threads. In this embodiment, the cannula assembly would contain an interior conical receptor capable of frictional connection instead of a raised ridge. The cannula assembly would frictionally mate with the conical protrusion of the first end 11 establishing a fluid communication pathway as described above.

In a second alternative embodiment, the opaque sleeve is manufactured as part of the syringe barrel. In this embodiment, there is not a separate syringe barrel but instead the syringe barrel and opaque sleeve are integrally combined as one unit. The syringe barrel would have an interior surface shaped cylindrically defining a tubular cavity and an exterior surface as described above. The material of the syringe barrel in this embodiment would be opaque with the exception of the inspection window. Predetermined volume markings would either be located on the exterior surface of the inspection window or towards the interior of the inspection window but the function would remain the same. In this embodiment, the plunger and cannula assembly would remain unchanged. The exterior surface would still cover a portion of the cannula assembly.

In operation, the exterior surface 34, angled needle 21, and plunger 40 disguise or conceal elements of a syringe that typically cause apprehension in children and adolescents. To use the present invention, a sterile cannula assembly is attached to the first end of the syringe barrel through threaded engagement or frictional engagement. The user then operates the syringe as taught by the prior art, carefully pulling the plunger away from first end 11 and drawing liquid through the angled needle into the tubular cavity. The user monitors the amount of fluid through the inspection window and ceases pulling the plunger away from the first end 11 once the desired volume is reached. The user then inserts the syringe into the patient's mouth, for a dental procedure, and dispenses a desired amount of liquid to the specified surface by pushing the plunger 40 towards the first end 11 and monitors the volume dispensed through the inspection window. The concealing functionality hides the fluid from view to the patient and relaxes the patient through the procedure as the invention does not look like a syringe while in use. Upon completion of the procedure, the cannula assembly is disposed while the remainder of the apparatus is sterilized and reused with a new cannula assembly.

The present invention is described above in terms of a preferred illustrative embodiment of a specifically-described fluid transfer protection sleeve. Those skilled in the art will recognize that alternative constructions of such an apparatus can be used in carrying out the present invention. Other aspects, features, and advantages of the present invention may be obtained from a study of this disclosure and the drawings, along with the appended claims.

I claim:

1. A syringe apparatus comprising a barrel containing a tubular cavity; a cannula assembly located on a first end of said barrel in fluid communication with said tubular cavity; a plunger capable of fitting within said tubular cavity through opening on a second end of said barrel; and an opaque sleeve positioned over said barrel wherein said opaque sleeve contains an inspection window capable of viewing said tubular cavity.

2. A syringe apparatus of claim 1 further comprising predetermined markings on said barrel identifying volume within said tubular cavity wherein said predetermined markings are viewable through said inspection window.

3. A syringe apparatus of claim 1 wherein said cannula assembly is removable from said barrel.

4. A syringe apparatus of claim 3 wherein said first end of said barrel has internal threads and said cannula assembly has at least one external thread capable of mating with said internal threads of said first end.

5. A syringe apparatus of claim 3 wherein said first end of said barrel has a conical protrusion and said cannula assembly has an interior conical receptor capable of frictionally engaging said conical protrusion.

6. A syringe apparatus of claim 1 wherein said cannula assembly contains an angled needle.

7. A syringe apparatus of claim 1 wherein said opaque sleeve covers a portion of said cannula assembly.

8. A syringe apparatus of claim 1 wherein said opaque sleeve covers at least said external thread of said cannula assembly when threadably mated to said barrel.

9. A syringe apparatus of claim 1 wherein said plunger is shaped to correspond with said opaque sleeve.

10. A syringe apparatus of claim 1 wherein said opaque sleeve is comprised of two halves mated around said barrel.

11. A syringe apparatus of claim 1 wherein said opaque sleeve is permanently affixed to said barrel.

12. A syringe apparatus comprising:
an opaque barrel with an inner surface defining a cylindrical tubular cavity and an exterior surface defining a shape differing from said inner surface further comprising an inspection window disposed through said opaque barrel;
a cannula assembly located on a first end of said opaque barrel in fluid communication with said tubular cavity; and
a plunger capable of fitting within said tubular cavity through opening on a second end of said opaque barrel.

13. A syringe apparatus of claim 12 further comprising predetermined markings on said opaque barrel identifying volume within said tubular cavity wherein said predetermined markings are viewable through said inspection window.

14. A syringe apparatus of claim 12 wherein said cannula assembly is removable from said opaque barrel.

15. A syringe apparatus of claim 14 wherein said first end of said barrel has internal threads and said cannula assembly has at least one external thread capable of mating with said internal threads of said first end.

16. A syringe apparatus of claim 14 wherein said first end of said barrel has a conical protrusion and said cannula assembly has an interior conical receptor capable of frictionally engaging said conical protrusion.

17. A syringe apparatus of claim 12 wherein said cannula assembly contains an angled needle.

18. A syringe apparatus of claim 12 wherein said exterior surface covers a portion of said cannula assembly.

19. A syringe apparatus of claim 12 wherein said exterior surface covers at least said external thread of said cannula assembly when mated to said opaque barrel.

20. A syringe apparatus of claim 12 wherein said plunger is shaped to correspond with said exterior surface of said opaque barrel.
